(19) United States
(12) Patent Application Publication
(10) Pub. No.: US 2023/0054518 A1
(43) Pub. Date: Feb. 23, 2023

(54) Method and apparatus for a data funnel interface with adjustable paths

(71) Applicant: H. Paul Zellweger, Rochester, MN (US)

(72) Inventor: H. Paul Zellweger, Rochester, MN (US)

(73) Assignee: H. Paul Zellweger, (omitted)

(21) Appl. No.: 17/300,567

(22) Filed: Aug. 20, 2021

(51) Int. Cl. G06F 16/2455; G06F 16/28

(52) U.S. Cl. CPC G06F 16/2455; G06F 16/284

(57) ABSTRACT

A data funnel interface with adjustable paths guides end-users to information in a relational table. The interface consists of one or more categories of user data derived from the set of user attributes in the database table. Each category of user data consists of human readable data in the table that conveys values relevant to the end-user. Selecting a data item from one category establishes a logical relationship with the next set of data in an unselected category. The end-user has random access to the categories of data and he or she is always free to choose a data item that either builds on an existing pathway or starts a new one. In the interface, alongside each category is a visual cue that indicates the status of an end-user’s data selection. Upon selecting a data item from each category in the interface, the system displays a Continue button to transfer the control to a window object that displays table information. The interface and its updated display of categories of data is generated automatically.

### REFERENCES CITED

10,169,405 Jan. 01, 2019 Neels, et al

RE46, 536 Sep. 05, 2017 Chasen et al.

9,665,637 May 30, 2017 Zellweger

8,977,662 Mar. 10, 2015 Hilliar

8,862,637 Oct. 14, 2014 Fachat

8,832,162 Sep. 09, 2014 Greenspan et al.

7,668,906 Feb. 23, 2010 Bolosky et al.

6,279,005 Aug. 21, 2001 Zellweger

6,131,100 Oct. 10, 2000 Zellweger

6,131,098 Oct. 10, 2000 Zellweger

5,630,125 May 13, 1997 Zellweger

### References

Anthes, Gary. Happy Birthday, RDBMS! Comm. of the ACM 53(5), 2010. 16-17. Comm. of the ACM 13(6). 1970. 377-387.

Burgin, Mark. Theory of Named Sets. New York: Nova Science Publishers. 2011.

Codd, Edgar F. A Relational Model of Data for Large Shared Data Banks. In Communications of the ACM 13(6). 1970. 377-387.

Codd, Edgar F. Extending the database relational model to capture more meaning. In ACM Transactions on Database Systems 4(4). December 1979. 397-433.

Date, Chris J. An Introduction to Database Systems, eighth edition. Boston, Massachusetts: Pearson, 2004, pp. 261-263.

Meeks, Elijah. “We Live in a World of Funnels, Understanding How Precision and Accuracy Are Competing Goals in Data Visualization.” Medium and Nightingale, The Journal of Data Visualization Society. Aug. 2, 2019. https://medium.com/nightingale/we-live-in-a-world-of-funnels-412d5c841d47

Zellweger, H. Paul. Simplifying the Structural Recursion of the Data Funnel Interface. The 25th International Conference on Information Visualization. (IV2021). Sidney, Australia. (July 2021).

Zellweger, H. Paul. Data Visualization and the Data Funnel Interface. The 24th International Conference on Information Visualization. (IV2020). Vienna, Austria. (September 2020).

Zellweger, H. Paul. The Branching Data Model, the Foundation for Automated Tree Visualization. The 22nd International Conference on Information Visualization. (IV2018). Salerno, Italy. (July 2018), pp. 323-328.

Zellweger, H. Paul. A Decision Tree Interface Based on Predicate Calculus. (IV2017). The 21^{st} International Conference on Information Visualization. London, United Kingdom. (July 2017), pp. 188-193.

Zellweger, H. Paul. Tree Visualizations in Structured Data Recursively Defined by the Aleph Data Relation. The 20th International Conference on Information Visualization. (IV2016). Lisbon, Portugal. (July 2016), pp. 21-26.

Zellweger, H. Paul. A Knowledge Visualization of Database Content Created by a Database Taxonomy. The 15th International Conference on Information Visualization. (IV2011). London, UK. (July 2011), pp. 323-328.

### CLAIM OF PRIORITY

Priority for the present application is claimed to U.S. Provision Applications 63/259,271, 63/259,270, 63/259,269, and 63/259,268 filed on Jul. 06, 2021.

### BACKGROUND - FIELD

This application relates to an end-user interface for a database system, in general, and to a data funnel interface with adjustable paths in particular.

### Background - Prior Art

Zellweger (U.S. Pat. 5,630,125) introduces a pioneering way to visualize data and data relations in the relational database with a content menu. This technology combines the opportunity to visualize nested sets of data in a database table along with the ability to navigate down these sets of data to pinpoint the information managed by the database table. The end-user views the relational data in the menu system as keywords that describe the information he or she wishes to see. One of the breakthroughs associated with this technology is the open hierarchical data structure (OHDS) that organizes the nested sets of relational data. This data structure arranges these subsets of data hierarchically, so the content menu can display them in a cascade of list menus. With the OHDS, every data item in one list connects to the next list of data in the structure. In the interface, the user drills down this structure by selecting one data item in each list menu of the cascade. This interaction follows the pathways in the OHDS flow. At the bottom, leaf nodes with primary key values as labels provide access to table information.

The primary advantage of the OHDS is that it is generated automatically (U.S. Pat. 6,131,100; U.S. Pat. 6,131,098; and U.S. Pat. 6,279,005). Its construction undergoes improvements influenced by the theoretical mathematics of algorithmic named sets. The arrangement of data in the OHDS provides a uniform way to retrieve nested sets of data from a set of table attributes, and then to store them in a computer file to locate table information. On a busy network, these files preserve server resources by minimizing unnecessary calls to the database when looking up a table row. Other advantages include the automatic production of multiple, related SQL SELECT statements that otherwise would have to be created by hand.

However, there is a problem with the prior OHDS format. In the end-user interface, once the end-user selects the first data item there was no way to change the underlying pathway. Selecting a data topic in one list menu always proceeds down to the next level in the OHDS to fetch the data for the next menu. Conversely, closing a list menu only moves the interface back up one level in the OHDS. In this respect, the content menu adheres to the root-to-leaf flow of the pathways in the OHDS. In the interface, these menu paths are fixed from top to bottom.

The current disclosure overcomes the problem of fixed pathways. It does so by introducing a new interface that supports adjustable paths. To accommodate this new adjustable capability the underlying data structure and the user interface have undergone significant change and innovation. The technology driving this new design comes from three newly discovered concepts. One is the branching data model (BDM), a formalization of the data relationships that occur between two table attributes (U.S. Pat. 9,665,637). With the BDM, the new interface now can provide random access to each category of data in a database table that describes an entity property. The second discovery focuses on a set of table attributes that Date calls user predicates. The inventor reverses Date’s contention that a row’s primary key approximates the set of user data by deploying the set of user data to retrieve the primary key. Finally, the third discovery replaces the former OHDS data structure with a simple database table format that streamlines the creation of data files for the new interface.

With these new advances, the current invention presents numerous advantages over the prior interface with fixed pathways. For instance, with the new interface the user can restart or reset a pathway at any time. The interface does this by displaying logically connected pathways alongside alternative data options drawn from the same attribute domain. Furthermore, newly discovered patterns in the pathways reveal that the nested sets of data progress in a systematic fashion the inventor calls a data funnel network. The predictable nature of this progression enables the new interface to add new visual cues, such as black and white bullets, to help the user keep track of his or her progress when looking up information.

Over the past century, the “funnel” metaphor started out as a figure of speech for breaking down the complexity of the sales process. This metaphor became popularly known as the “sales funnel.” More recently, it has been taken up in data science, like in U.S. Pat. 7,668,906, where the “data funnel” metaphor encourages us to view the complexity of data in communications in an orderly, connected progression. In contrast, the inventor identifies the current disclosure as a “data funnel” interface because it organizes the nested sets of relational data in a funnel shape that narrows down to single data value, a primary key. Remarkedly, this funnel shape of data in this new visualization interface combines both accuracy and precision, unlike other types of data visualizations where these two characteristics compete.

The funnel pattern in the present invention always starts with a list of the data from a single table attribute. This starting point represents the attribute’s data domain. Each individual value logically connects to a subset of data in the next attribute. With the BDM, the linkage between these two attributes, as the reader will soon see, maps from a dataset to a subset of data. In the interface, each new selection narrows down the number of items in the next data display. This process repeats itself until the system displays an information window. The inventor calls these values user data according to Date’s understanding of user predicates. While Date proclaims that a primary key approximates a set of user data, the inventor, as indicated before, reverses his argument and by allowing the user to select a set of user data in a table row to look up a primary key.

At the end of each pathway in the data funnel interface there is a primary key label. The inventor contends that the progression of these nested sets of data draws on the underlying mathematics of the relational model that Codd describes as predicate calculus.

Although the relational database is over fifty years old, and with active research conducted throughout this time, there are still some areas of these systems that have remained overlooked. For example, there has been no formal study of the uniform patterns of relational data in the database table from the perspective of retrieval operations. While these patterns can and do become clear in a snapshot of the relational table, the real-world setting of the table makes them difficult to fully consider as a uniform pattern. However, after constructing a well-formed query for the new interface patterns in the query and its data highlight this uniformity in the schema and its data content.

Other prior art reviewed here refers to individual components of the current invention in isolation. These subsystems include moving one data model to another, a newly discovered disk file format, and advances on the work of the query and query templates.

For instance, U.S. Pat. 10,169,405 discloses advances to the database query and the query template. However, unlike the current invention no aspect of this prior art is generated by automated methods. Another prior art form, U.S. Pat. 8,977,662 teaches about a file management system that is hierarchical, but this system limits itself to a bulk storage system outside of the database system. U.S. Pat. 8,832,162 employs tags on the data to classify and distribute information concerning relations between data, but the data in this invention also exists outside the database system. In another instance, U.S. Pat. 8,862,637 presents a data model to access a database system, but the retrieval in these systems is based entirely on the semantics of the data model and not on the structural aspects of the data model matching the database schema. And finally, U.S. Pat. RE46, 536 advances the art of meta data in conducting searches, yet these searches are associated with search engines that operate at a higher level of abstraction than the relational database. They produce a list of results that have a “hit or miss” reputation, while the results from the RDBMS are always both accurate and precise.

In conclusion, there are a number of clear benefits with the new data funnel interface. First, as mentioned before, the new interface system with adjustable pathways is generated entirely by automation. There is no need to add any program code whatsoever. Second, the user is now able to access relational data according to an approach that contextualizes the data for each category of data shown. And finally, the user can access each category of data in any order that he or she chooses.

### DRAWINGS BRIEF DESCRIPTION OF THE FIGURES

FIG. 1 depicts the prior art of a content menu, a data funnel that organizes data and data relations in a database table according to fixed paths.

FIGS. 2A and 2B depicts the flexible layout of the data funnel interface.

FIG. 3 displays the sample database table used to demonstrate the data funnel interface.

FIG. 4 displays a branching data model (BDM) in the sample database.

FIG. 5 presents the uniform branching data model between two table attributes.

FIG. 6 displays the data funnel network (a.k.a. BDM data network) in the database table.

FIG. 7 presents the network architecture for the new data funnel interface.

FIG. 8 shows the software components used to configure for the data funnel interface.

FIGS. 9A to 9C depict the configuration interfaces for the new data funnel interface.

FIGS. 10A and 10B represent the data validation processes for the new data funnel interface.

FIGS. 11A to 11E display the request and response patterns for the runtime option of the interface.

FIG. 12 depicts the pseudocode of the algorithm that generates the data files from the Subset table for the new data funnel interface.

FIG. 13 presents an overview of the collection of data files for the new interface.

FIGS. 14A to 14F depict a user scenario of the new data funnel interface.

### DRAWINGS - DETAILED DESCRIPTION

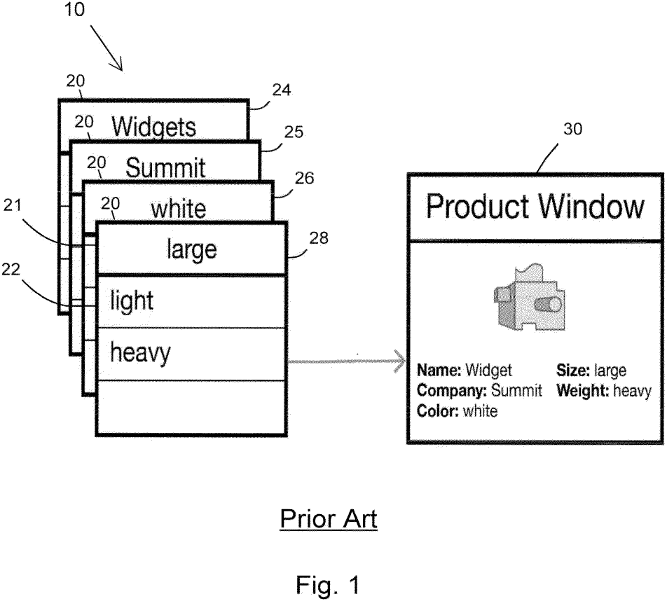

FIG. 1 graphically depicts the prior art of an end-user interface to the relational database known as the content menu. In one embodiment, content menu 10 consists of one or more nested list menus 20 that display a cascade of data and data relations extracted from a database table. Each list menu 20 has a title 21 followed by a set of raw data in region 22. For the user, the data in menu 20 represent keywords that describe properties of the information managed by the table. The end-user selects a data value in one menu 20 to navigate down one level of the data and data relations in the table. The selection of these data keywords creates a pathway. At the bottom, the content menu 10 displays a window that presents information associated with their data selections.

In this depiction of content menu 10, the pathway starts at list menu 24 and finishes in menu 28. The user can either drill down to the bottom of the path or close a list menu 20 to move back up. An underlying data file controls the flow of data from one list to the next. From top to bottom, each pathway is fixed.

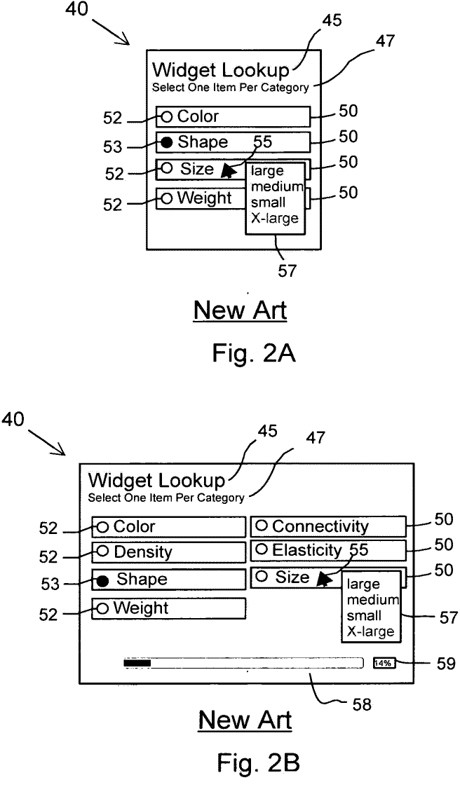

The new art of data funnel interface 40 is depicted in FIGS. 2a and 2b. As before, interface 40 enables users to conduct table record lookup to information managed by a database table. Interface 40 and its underlying data file are also generated automatically. However, unlike the prior art, interface 40 allows users to restart or reset a pathway at any time.

As one would expect, interface 40 introduces a new interactive user experience. One part of this new experience comes from the new features in interface 40. Another part comes from the underlying data files that constantly update the new view in any of the unselected categories.

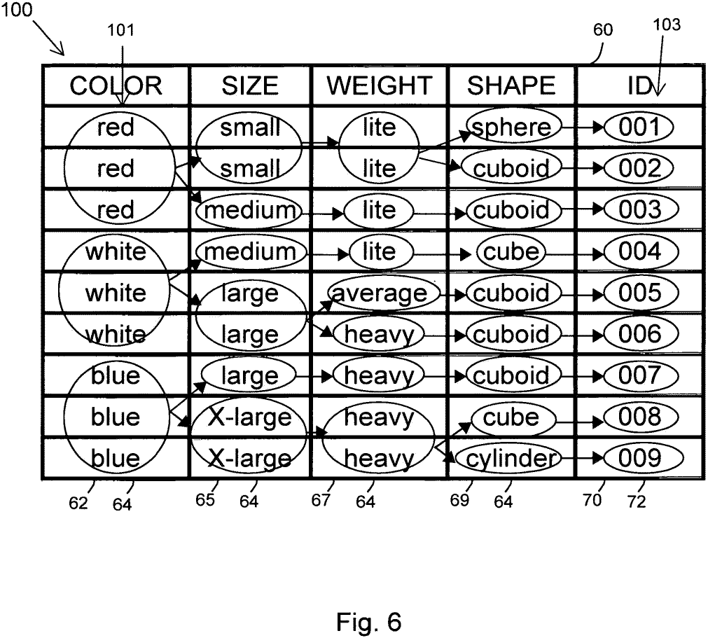

This new view of the data in a table is the data funnel network presented in FIG. 6. Its funnel shape consists of a progressive series of subsets, one per well-defined set of table attributes. Together, this new data file format and the new interface operate in a coordinated fashion to out lay out the foundation for the adjusted pathways.

A second critical feature of interface 40 focuses on how its display renders to different screen sizes. The new interface 40 displays one or more category 50 of data. In FIG. 2A, the drawing presents a column display of its categories of data for mobile devices. While FIG. 2B presents the same categories in a GRID layout that goes let-to-right in a top-down fashion.

Each category 50 of data (or attribute) represents a well-defined attribute in table 60. The data values for each category 50 represent a human readable property of the information modeled by table 60. Date describes this data as being responsible for user predicates, or expressions that relate to the user, as opposed to system predicates, or keys, that refer to strictly to the operations of the database system.

On interface 40, each category 50 is bound by a well-marked region. Each region has a label that describes its data in easy-to-understand terms. It also has a bullet graphic that signals a work-in-progress status. A black bullet 53 signals that the user has selected a data value associated with category 50. A white bullet 52, in contrast, indicates that a selection still needs to be made.

The data display in interface 40 is contextualized and context sensitive. When a user clicks a cursor 55 in a category 50 region, the software for interface 40 displays a pop-up window 57 of data values. Depending on the size of the data list, this pop-up window has an overlapping display for small sizes, such as 6 or fewer items, or a pop-up window that covers the entire screen.

The list of data values in window 57 include black font items, like small, medium, and large, as well as fonts in a light-gray color, such X-large. A black font data value represents an option logically associated with a prior selection made in the Shape category 50. Alternatively, a light-gray font data value restarts the pathway at the current SIZE category as a new beginning point.

Subsequently, the use of black bullets 53 and white bullets 52 alongside each category label in interface 40 provides the user with a “to do” list. It designates the data selections made so far from the other categories that still need a data selection.

One other feature of interface 40 needs further explanation. In both FIGS. 2A and 2B, there is a fixed region of categories of data 50. These categories are Color, Shape, Size, and Weight. However, there is default scrolling region panel underneath the title 45 and end-user instruction 47 fields. This default scrolling panel displays a scroll bar on the left column of the panel to allow the end-user to display a category of data 50 that is not visible. The relative position of the tab on the scroll bar indicates that in addition to the categories of 50 on display there are one or more categories of data 50 above and/or below. The end-user moves the tab along the scroll bar to reach these unseen objects.

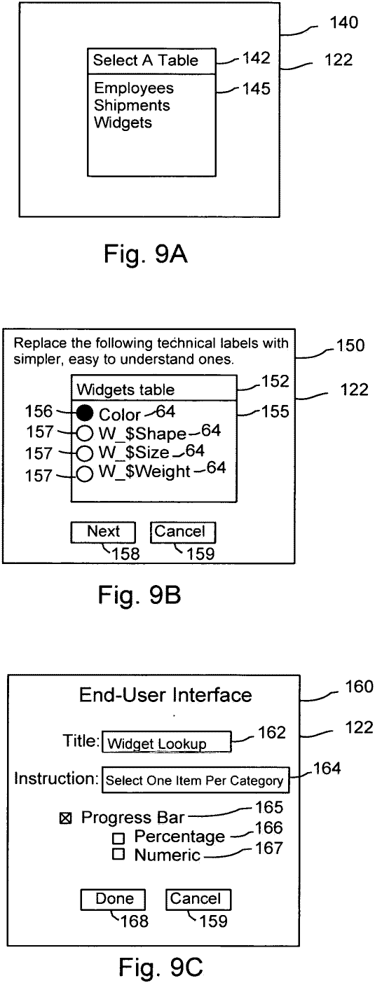

Interface 40 is constructed using a “configure, not code” approach. The components of interface 40 that a developer user can configure on setup include a title 45 that informs the end-user on the purpose of the form. They also include an instruction 47 that tells the user what it expects the him or her to do. The details of the configuration process include the forms presented in FIGS. 9A through 9C.

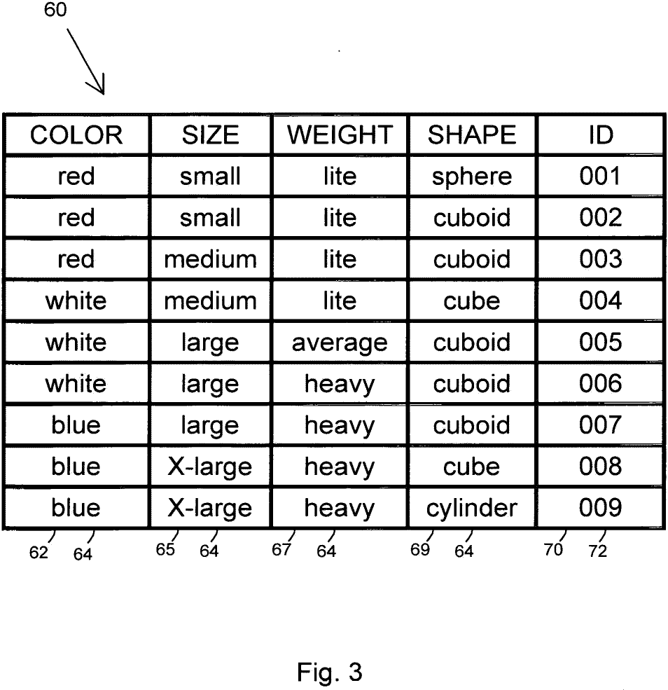

In FIGS. 3though6 , the drawings present the sample data used to explain and demonstrate the unseen parts of the invention. Database table 60 in FIG. 3 represents the Widgets table, a collection of generic technical products. The table has five attributes and nine rows of relational data. While the size of the data in the Widgets table is toylike its duplicate values represent scalable patterns found in all database applications.

In table 60, the ID attribute 70 manages the primary key values for each row. In keeping with relational theory, each value in ID 70 is unique and none of its values are null. Date describes this attribute and its data in terms of system predicates, pp 261-263. Throughout the preferred embodiment of this new art, a single table attribute manages the primary key values. In alternative embodiments, more than one table attribute can represent a primary key.

The remaining attributes in table 60 are COLOR 62, SIZE 65, WEIGHT 67, and SHAPE 69. All these attributes manage a specific type of data associated with the present invention. These data values represent the human readable properties of the entities modeled by the database table. Date refers to this data in terms of user predicates. Subsequently, the inventor identifies this type of data as user data 64.

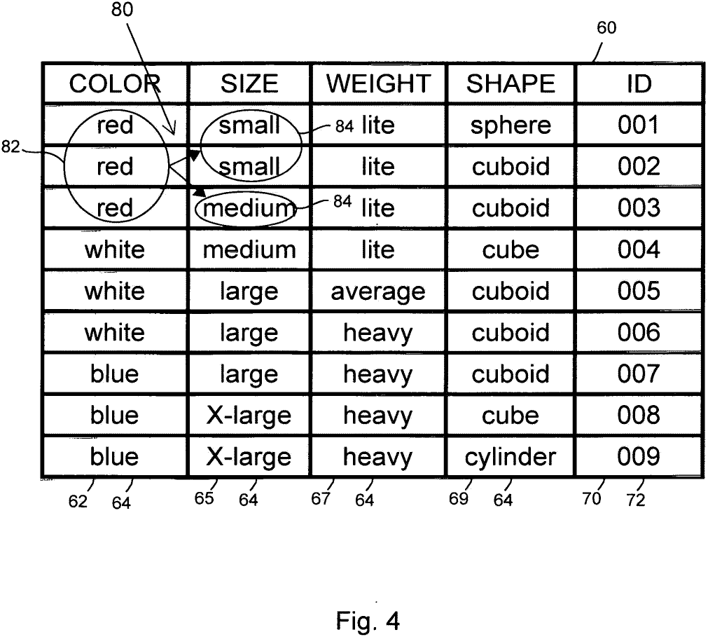

In FIG. 4, a simple branching data model or BDM 80 is displayed in table 60. The construction of BDM 80 is initiated by the well-defined SQL SELECT statement listed below at 1.

SELECT SIZE From Widgets WHERE Color = 'red' (1)

This query at 1 consists of a data condition that self-references the COLOR data domain by its red target value. The value red represents input data 82. This target condition sets up the query to return unknown application values. In this simple demonstration, small and medium are data output 84. Outside of the execution of the SELECT statement, program logic arranges the input data 82 red alongside its output 84 small and medium in memory. Logically speaking, output data 84 is dependent upon input data 82. Remarkedly, table 60 in FIG. 4 depicts the BDM arrangement of data 80. However, this depiction, as mentioned earlier, is a snapshot frozen in time and space; it does not represent the unordered, 3-dimensional space of the relational table.

Table 60 does, however, show us how we can see the data relations between two table attributes using our well-defined SELECT statement at 1. Furthermore, we can construct this arrangement of data according to the input and output data used by the query. This designation of data relations according to its input and output roles is important for two reasons. First, its branching shape represents a primitive tree structure. Second, its end points are composed of digital symbols that can connect to other such structures by program logic. The ability to establish these connections expands by adhering to the uniform patterns in retrieval operations and modeling expressions.

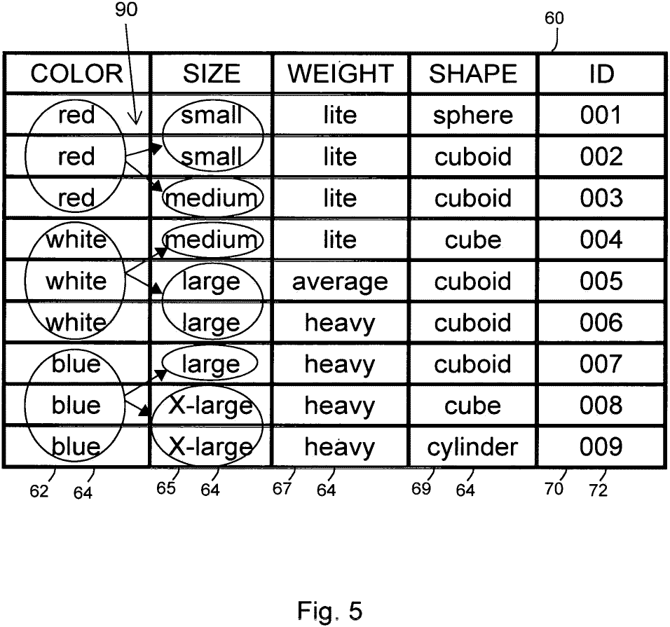

In FIG. 5, we expand the BDM 80 shape between two table attributes. To accomplish this expansion, we now need to consider the SELECT statement as having an input variable v for its target data conditions. This time, the program control outside of the query passes the conditions red, white, and blue to the v in the SELECT statement. Now each time the retrieval command executes, the program logic outside of the query lines up data input 82 with its output values 84 in memory on the computer. We can capture these data values, v and its data output, and plot them, once again, in table 60. In this depiction, a uniform nature of BDM pattern 90 takes shape between input data 82 and its output values 84. It reveals a consistent data relationship between these two attributes as having an upper bound cardinality of one-to-many.

In addition, the well-defined SELECT at 1 on the prior page has one more thing to offer. Its input attribute COLOR 62 and its output SIZE 65 represent a pair of table attributes that can serve as meta-query data for BDM pattern 90. In notation, “(COLOR, SIZE)” models the data relationship 90 as a BDM 90. It also renders the well-defined SELECT statement as a template of keywords. By separating out the input and output attributes in the SELECT statement the process lays the foundation for automating the construction of a more complex object.

In our next BDM expansion, we can extend the BDM expression to represent a data network in table 60. To generate this data network, we pass a chain expression of attribute labels to a recursive algorithm, like the one described by Zellweger in 2010. An example of this chain expression is located below at 2. This BDM chain expression includes all the table attributes that manage user data 64. The final link in this expression has the table’s primary key in its output position.

(COLOR, COLOR) (COLOR, SIZE) (SIZE, WEIGHT) (WEIGHT, SHAPE) (SHAPE, ID) (2) In FIG. 6, a recursive algorithm traces out the BDM network 100 shown in table 60. Each link in the chain has an explicit input attribute, and its data value 82, and an explicit output attribute, and its implied values 84. More importantly, each input data element 82 establishes a dataset in table 60 and the output data 84 depicts its subset.

In the chain expression at 2, each new link overlaps a prior one, whereby the output data 84 in one link becomes an input data 82 for the next link. The recursion progresses through the chain links to generate the nested subsets of data depicted in output data 84. On each iteration, these subsets of data narrow down the field until one final value is reached, a primary key. However, given the challenge of modeling relational data — and its lack of order — we make the conjecture that this chain expression traces out the BDM network 100. This conjecture is based on the predictable nature of SELECT operations, and on our ability to capture its pairs of input data 82 and output data 84.

The inventor calls the BDM network 100 in table 60 a data funnel network. The funnel structure starts at 101 and logically progresses through the sequence of user attributes in table 60 to a leaf node 103 at the other end of the network. This progression reveals a uniformity of elements, user attributes and their data, that traverses across table 60 in a predictable fashion; it always ends with a primary key label on a leaf node.

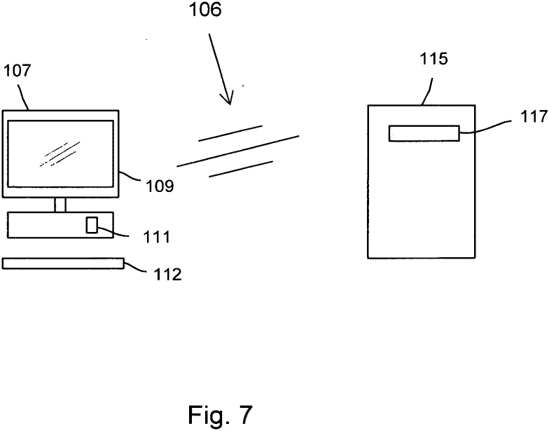

In the next drawing, FIG. 7 displays the preferred embodiment of the hardware architecture for the data funnel interface 40. Computer 107 is electronically linked to another CPU, computer 115. The linkage 106 includes any combination of physical cabling and wireless connections. Computer 115 has a CPU 117 that controls its program flow. Computer 115 provides the menu data for the data funnel interface 40 displayed on monitor 109 of computer 107. Computer 107 also has a CPU 111. Computer 107 has communications software that enables it to request menu data from computer 115. End-users on computer 107 employ a keyboard 112 on 107 to make selections that enable them to interact with the new data funnel interface 40.

Alternative input devices on computer 107 include touchscreens; pointing devices, such as a mouse; voice-activated systems; and other types of sensory input devices that enable end-users to select values in the new data funnel interface 40. Monitor 109 of computer 107 displays the new interface 40 visually as a graphic image; alternative output devices include “talking software” systems that would enable the end-user to receive auditory descriptions of the new data funnel interface 40 presented by computer 107.

Alternative embodiments to the network configuration 105 of the present invention include a stand-alone computer, such as computer 107. In this embodiment, both the data file 130 and the data funnel interface 40 reside on computer 107. Additional alternative embodiments to the stand-alone computer include any computing device, regardless of its size or sensory interaction, that would enable an end-user to interact with the interface 40 by selecting a progressive sequence of data, which eventually culminates in an information display.

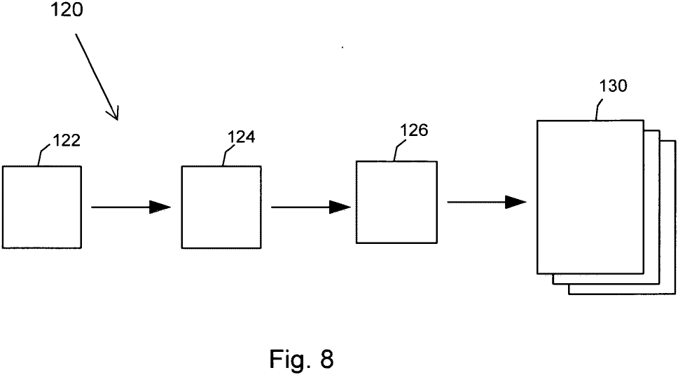

In FIG. 8, the drawing presents the high-level software components 120 of the present invention. The first component is the configuration interface 122 for system 120. The configuration interface 122 enables a citizen developer to connect to a database system, specify a single table from a list of tables, and proceed onwards. Other forms in interface 122 set up the display details for interface 40. Next, verification system 124 validates the data and data relations in the table selected by the developer. And finally, recursive algorithm 126 generates one or more data files 130 for the new data funnel interface 40.

The next three figures, FIGS. 9A through 9C, display the interfaces associated with the configuration subsystem 122. In FIG. 9A, interface 140 displays a list of the database tables in region 145. The command “Select A Table” 142 asks the citizen developer to choose a specific table for the data funnel interface 40.

When the citizen developer selects a table, interface 140 transfers the display to the image portrayed in FIG. 9B. In interface 150, the Widgets table title 152 heads a list of the user attributes 74 in table 60 in region 155. Each attribute label from the selected table typically has a technical look that makes little or no sense to a user. Upon placing a cursor 55 on an attribute label area, a pop-up entry form appears. The form is ready to receive a new, alternative name that easy to understand. A carriage return captures the new name and transforms its white bullet 157 to a black one 156. When all the user attribute labels in table 60 have been replaced with easy-to-understand category names interface 150 displays the Next button 158 at the bottom of interface 150.

In FIG. 9C, the End-User Interface 160 takes over the display space. The developer adds a title to interface 150 in field 162 and an instruction to the end-user in field 165. These two fields correspond to the tile 45 and instruction 47 in the new data funnel interface 40 As before, a carriage return completes the data entry. When the developer adds both fields, the Done button 167 appears at the bottom of the form. Selecting button 167 transfers control to the data validation processes.

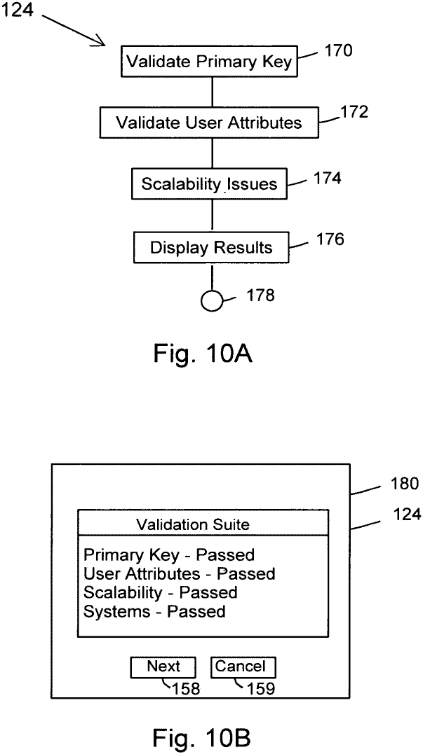

In FIG. 10A, the system conducts the data validation routines 124. These processes start at 170 with the validation of the primary key in table 60. Its routines include queries and code to verify that every primary key in the table is unique; no primary key is NULL; and the table row count is equal to primary key count. Next, at 172, each user attribute in the table undergoes a test query condition for NULL values. In process 174, the system determines the number of user attributes in the table and the exact number of unique data values. And finally, at 176 the system determines if any of these tests or their results are inconsistent with any of the metrics collected so far. At this point, a brief statement of the final outcomes is displayed on the developer’s screen.

Feedback to the developer includes both a window display and a log file. FIG. 10B presents an overview of display window 180. The information in window 180 includes the details on any problems with individual primary keys, table rows, and the descriptive attributes. At the bottom of interface 180, the developer selects the Next button 158 to generate one or more data files 130 for interface 40.

The algorithms that generate data files 130 comes next. Data files 130 include the setup details for the interface, such as its title 162 and instruction 164, as well as the actual subsets of data associated with each category data list 57. In the preferred embodiment of the current invention, the category data list 57 is generated at runtime. The alternative embodiment generates the entire collection of category data list 57 files and stores them on the server.

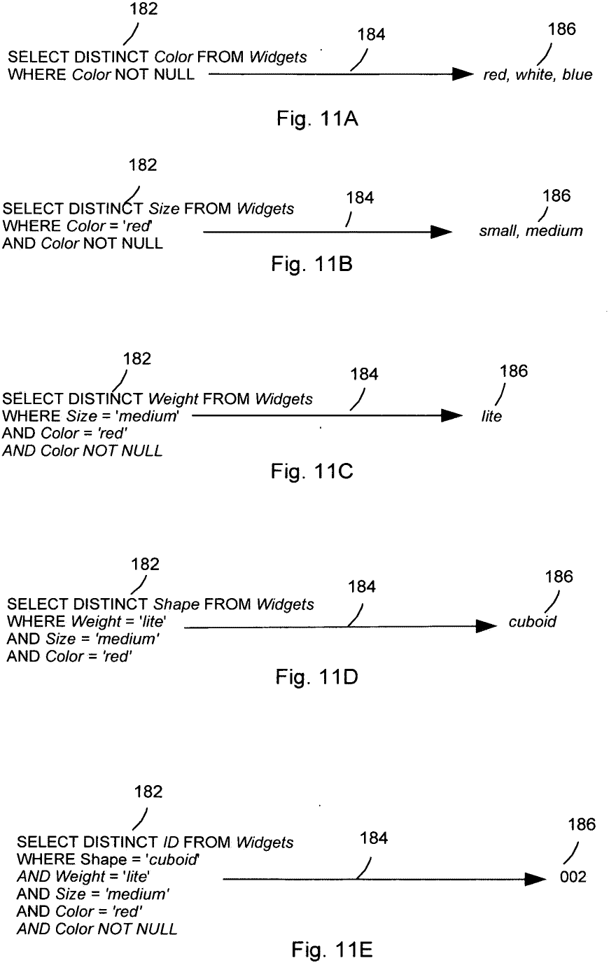

In the next series of drawings, FIGS. 11A to 11E, the display shows the progression of request and responses between computer 107 and network server 115. In FIG. 11A, the request indicates that the user has selected the Color category. Software on server 115 conducts the SELECT operation and returns the data domain of Color in table 60, notably red, white, and blue. After the user selects red in the Color category, she clicks on the Size category and interface 40 makes the requests presented in FIG. 11B. This new query now includes the most recent data selection in the data condition Color = ‘red.’. The server responses with its output data, small and medium. In FIG. 11C, the user clicks on Weight category and the server responds with the lite output data. And finally, in FIG. 11D, the interface displays the last user value cuboid

Each time the user clicks on a category region in interface 40, its software expands with a well-defined SELECT statement. This includes a single output attribute drawn from the current category. It also includes one or more data conditions drawn from any prior data selections.

In the final request made in FIG. 11E data selections have been made over the entire set of user attributes. With these data constraints the system requests the data output for ID, the primary key.

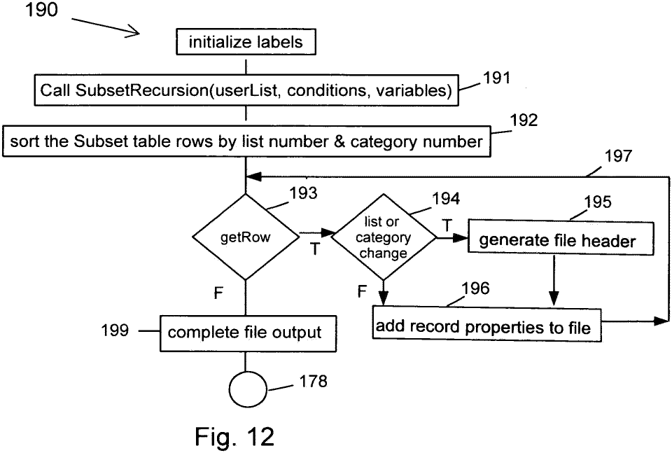

In FIG. 12, the pseudocode presents an overview of the recursion and production processes used to generate the data files for the new interface. There are four high-level executive functions accomplished by algorithm 190. They include:
Populate a data structure with subsets of data from each user attribute in a database table.
Sort the data structure according to its subset list number and its user attribute or category.
Step through the results in the data structure, one row at a time.
Separate each file and generate the collection of files.

In the preferred embodiment of the invention, setupRecursion gets called at 191 to store each data value of a subset in a table row. Table 1 below displays the basic properties of these values in the Subset table. In the alternative embodiments, system 190 employs data structures, XML, or RDF to record and manage these properties.

Table 1

SUBSET
Data Value
List Number
Category Number
Next List

At 191, the setupRecursion routine gets called. The input data for the recursion is userList, a BDM expression of user attributes, that generates a permutation of data funnel networks shown in the next drawing. Each pathway in the network starts with the user attribute’s data domain, one per user attribute in the table. Next, each element in the domain proceeds downward through the remaining user attributes in the table. This process repeats itself until the user List is empty. At the end of each path, as indicated before, a leaf node has a primary key value label.

At 192, system 190 sorts all the records in the Subset table by their list and category numbers. Next, at 193 it steps through each Subset table row in loop 197 looking for changes in the list number and then category number. As a given list item can connect to one or more dependent lists, each dependent list has the same list number. But each dependent list also has a unique character number. At 194, when a list or category number differs the program generates a new file header at 195. Now while the dependency list numbers are the same the data content in each list corresponds to its category number. This procedure enables the user to request a list of data based on the selected category. The next list variable is stored locally in the interface and refers to any number of dependency lists, but the category number is determined at runtime. The combination of these two fields reveals the specific data file needed.

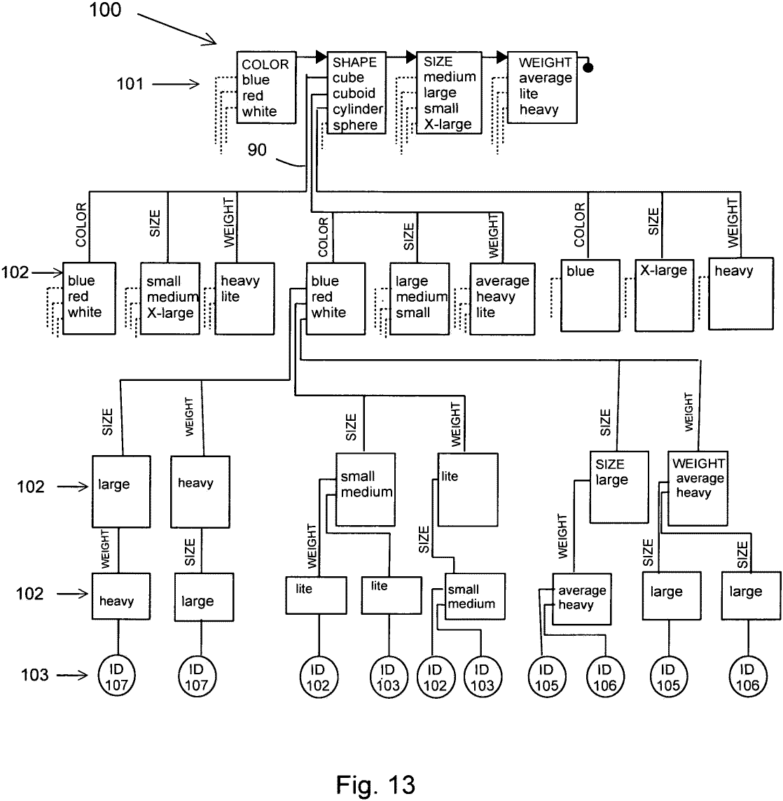

In the next drawing, FIG. 13 presents an overview of the organization of the data files used by the new interface. The logical organization of these files is a hierarchical list of nested lists. In every production, the hierarchy has at least two or more levels. The data funnel structure 100 starts at 101 with a data domain for each user attribute or category in the user List. An optional level 102 comes next. At the bottom of structure 100, there is a leaf node 103 that has a primary key label.

Each data element in a list of structure 100 has a pointer 90 to one or more dependency lists at the next lower level in the hierarchy. Each dependency list has the same list number that it combines with the list’s category number (or identifier) to make each file in the collection unique. Therefore, pointer 90 combines the next list number with the category number selected on the interface to name each data file in the collection.

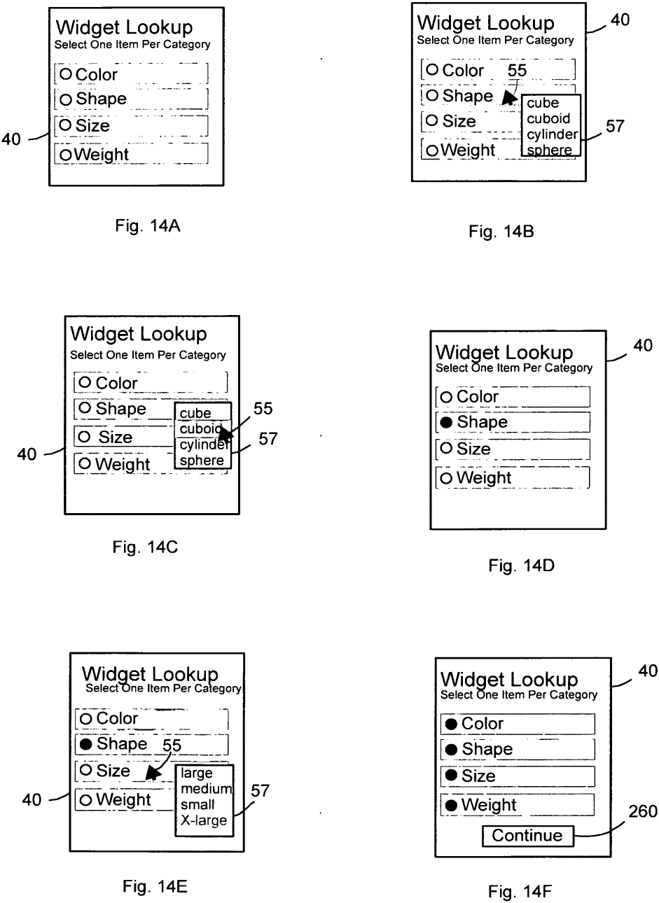

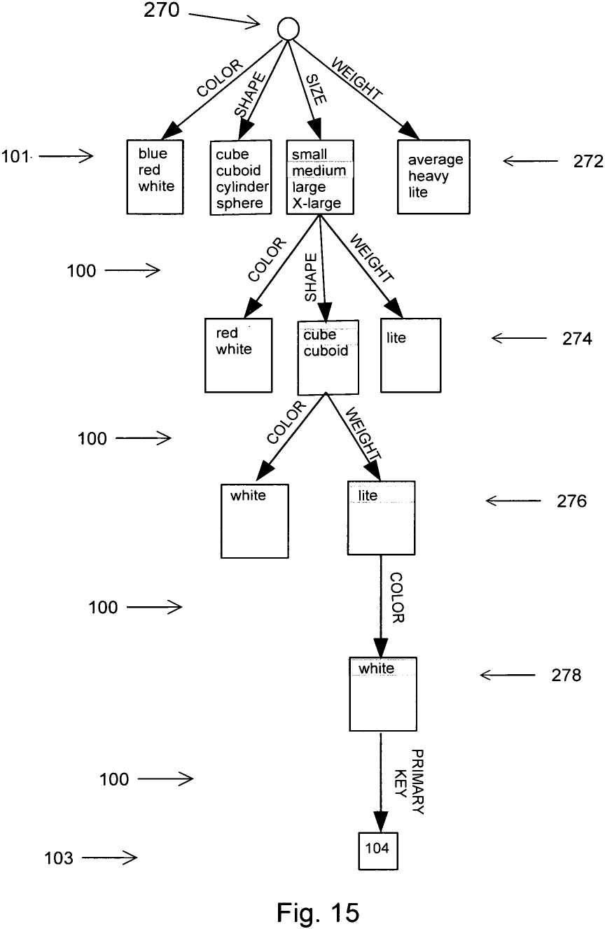

Now to demonstrate how the new data funnel interface 40 operates FIGS. 14A through 14F present an end-user scenario. The popup data list 57 associated with the demonstration represents a short list of data.

In FIG. 4A, the user first sees interface 40. It has a title, user command, and display of categories that represent the set of user attributes in a database table.

In FIG. 14B, the user clicks on the Shape category region of interface 40. This action triggers pop-up window 57 to display its data domain. These values include cube, cuboid, cylinder, and sphere. Note how prior to the user’s first data selection all of the data values in window 57 are black font.

In FIG. 14C, the user points cursor 55 on the cuboid option in pop-up window 57 and clicks on it to make a selection. Instantaneously, interface 40 performs two actions. First, it displays a light gray band under the selected item in window 57. Next, it transforms the white bullet 52 to a black bullet 53 in FIG. 14D to indicate a data selection.

After an item gets selected, a click on a new category, such as Size in FIG. 14E, the system displays a more complex pop-up window 57. This time the list of data in window 57 includes data values in both black font and light-gray font. The black-font values represent a nested set of data based on the prior selection of cuboid in the Shape category. The light-gray font value, notably X-large, represents an option to restart a new pathway that begins with the SIZE category.

Upon accessing a light-gray font item, such as X-large above, interface 40 would restart the logical connections in table 60. All the previous black bullets now display white bullets and only the current category would have a black bullet

In the final step, each category 50 in interface 40 has a black bullet. FIG. 14F displays this last state. The software associated with interface 40 now displays a Continue button 185 at the bottom. The end-user selects button 185 to transfer control to an information window 30 to display the table information associated with his or her prior data selections.

### CONCLUSION

This concludes the description of an embodiment of the invention. The foregoing description of the embodiment of the invention has been presented for the purpose of illustration and description. It is not intended to be exhaustive or limit the invention to the precise form disclosed. Many modifications and variations are possible considering the above teaching. Furthermore, the scope of the present invention is not intended to be limited to a relational database system, the technical setting used to disclose this invention, but rather by the claims appended hereto.

Having described an embodiment of the invention I claim:

1. A computer system proving the means for generating a data funnel interface for retrieving individual records from a database table consisting of:
a configuration system that provides the means for a developer to select a table in said database system,
an end-user interface that provides an underlying structure and components of said data funnel interface,
a data file consisting of a subset of data from an attribute in from said database table for said data funnel interface,
a retrieval routine that reads said data file to fetch said nested set of data to update a data display in said user interface.
a selection routine for said data funnel interface that marks a data item selected by an end-user and that transforms a visual progress cue on said data funnel interface to a new state.
whereas, providing the means for generating said data file for said data funnel interface effectively enabling said data funnel interface to be constructed entirely by automation.

2. The computer software system of claim 1, wherein said assemblage of software program logic of said data funnel interface is implemented in at least one computer language.

3. The storage structure of claim 1, wherein said storage structure is compatible with at least one data model, one data structure, and one file structure.

4. The storage structure of claim 1, wherein said storage structure establishes a logical relationship between said end-user label and said structural element of said source of data.

5. The data source of claim 1, wherein said data source is an external system that is compatible with at least one data model, one data structure, and one data file format.

6. The administrators’ interface of claim 1, wherein said administrators' interface is implemented in a computer language that is compatible with at least one graphic user interface computer language.

7. The administrators’ interface of claim 1, wherein said administrators' interface provides the means for granting and denying access at the table and attribute levels when said data source is a database system.

8. The administrators’ interface of claim 1, wherein said administrators' interface provides the program logic means for implementing a rule-based translator that can locate a character string in a technically oriented label that refers to said structural element in said data source and that can replace said character string with an EUL character string to create said end-user label.

9. The administrators’ interface of claim 8, wherein said administrators' interface provides the program logic means for managing a collection of said rule-based translator.

10. A computer software system proving the means for generating a data funnel interface for accessing individual records in a database system consisting:
a configuration system that provides the means for a developer user to select a database table in said database system,
a template user interface for said data funnel interface that provides a generic structure for said data funnel interface,
a data file from said database table for said data funnel interface that provides an interface content for said template user interface.

11. The computer software system of claim 10, wherein said assemblage of software program logic of said data funnel interface is implemented in at least one computer language.

12. The storage structure of claim 10, wherein said storage structure is compatible with at least one data model, one data structure, and one file structure.

13. The storage structure of claim 10, wherein said storage structure establishes a logical relationship between said end-user label and said structural element of said external source of data.

14. The data source of claim 10, wherein said data source is compatible with at least one data model, one data structure, and one data file format.

15. The administrators’ interface of claim 10, wherein said administrators' interface is implemented in a computer language that is compatible with at least one graphic user interface computer language.

16. The administrators’ interface of claim 10, wherein said administrators' interface granting and denying access at the table and attribute levels when said data source is a database system.

17. The administrators’ interface of claim 10, wherein said administrators' interface implementing a rule-based translator that can locate a character string in a technically oriented label that refers to said structural element in said data source and that can replace said character string with an EUL character string to create said end-user label.

18. The administrators’ interface of claim 17, wherein said administrators' interface implementing said rule-based translator that includes providing the program logic for managing a collection of said rule-based translator.
